(19) United States
(12) Patent Application Publication
(10) Pub. No.: US 2021/0295396 A1
(43) Pub. Date: Sep. 23, 2021

(54) DEMOGRAPHICALLY CONGRUOUS REVIEWS

(71) Applicant: Dell Products L.P., Round Rock, TX (US)

(72) Inventors: Donal Carpenter, Wicklow (IE); Mahuya Ghosh, Hyderabad (IN)

(73) Assignee: Dell Products L.P., Round Rock, TX (US)

(21) Appl. No.: 16/821,109

(22) Filed: Mar. 17, 2020

(51) Int. Cl. G06Q 30/02; G06N 20/00

(52) U.S. Cl. CPC G06Q 30/0282; G06N 20/00

(57) ABSTRACT

Systems and methods display reviews of products and/or services that are most demographically congruous with the individual seeking those reviews. An individual selects a product for which reviews are to be shown. The system and method form a graph having nodes representing the individual, product reviewers, demographic characteristics, reviewed products, and product reviews. The system and method then determine demographic closeness in the graph between nodes of the individual and those of each reviewer of the selected product, where the individual may be connected to a reviewer either by a common demographic characteristic or through such a characteristic associated with another product reviewed by that reviewer. The system and method use these values to compute a demographic congruity (DC) score for each reviewer, and rank the reviews for display according to these DC scores. Statistics may be compiled for reviewers with DC scores exceeding a given threshold.

### FIELD

The disclosure pertains generally to data processing systems and methods, and more particularly to computerized arrangements for providing personalized reviews of products or services.

### BACKGROUND

Product and service reviews are subjective, being based at least in part on demographics of the reviewer. Many demographic factors may influence the review such as gender, age, ethnicity, location, relationship status, education, and so on. It's fair to assume that people who have similar demographic profiles may share similar experiences of the same product or service, while people who have diverse profiles may not. However, the demographics of reviewers may be different than the profile of a person who is seeking the reviews, even for those interested in the same product or service.

Existing online product and service review sites rank reviews and provide related statistics according to several different criteria, including: recency of the review, number of “stars” awarded by each reviewer, number of “up votes” of a particular review by other reviewers, and total number of reviews by a reviewer. However, these sites indiscriminately present statistics and reviews made by all those who have reviewed the selected product or service, and such summary statistics may be misleading if a significant number of the reviewers have different demographic characteristics than the person viewing the reviews.

### SUMMARY OF DISCLOSED EMBODIMENTS

Disclosed embodiments of the concepts, techniques, and structures disclosed herein improve the art by displaying reviews of products and/or services from reviewers who are most demographically congruous to the viewer. This is accomplished by forming a graph having nodes representing the individual, product reviewers, demographic characteristics, reviewed products, and product reviews. Next, demographic closeness is determined in the graph as the number of edges between nodes of the individual and those of each reviewer of the selected product, where the individual may be connected to a reviewer either by a common demographic characteristic or through such a characteristic associated with another product reviewed by that reviewer. Demographic closeness values are used to compute a demographic congruity (DC) score for each reviewer, and the reviews are ranked for display according to these DC scores. To provide only the most congruous reviews, embodiments may select for display (and for statistical summary) only those reviews whose reviewers have DC scores exceeding a given threshold.

Thus, a first embodiment is a system for providing product reviews to an individual, the product reviews having been made by a plurality of reviewers. The system includes a communication device configured to receive a selection by the individual of a product from a plurality of products. The system also includes a graph former, configured to form a graph having nodes representing the individual, the plurality of reviewers, demographic characteristics belonging to the individual and the plurality of reviewers, the plurality of products, and reviews of each of the plurality of products by the plurality of reviewers. The graph has edges representing relationships between the nodes. The system has a congruity scoring processor, coupled to the graph former and the communication device, the congruity scoring processor configured to compute, for each reviewer of the selected product, a respective demographic congruity (DC) score that relates a demographic closeness between the reviewer and the individual. And the system has a thresholding processor, coupled to the congruity scoring processor and to the communication device, the thresholding processor configured to determine a threshold DC score. The communication device is further configured to provide simultaneously to the individual (a) statistics relating to a first group of all product reviews of the given product, and (b) statistics relating to a second group consisting of only those product reviews whose reviewer has a DC score that exceeds the threshold DC score.

In some embodiments, the congruity scoring processor is further configured to form a path comprising nodes and edges in the graph between the node representing the reviewer of the selected product and the node representing the individual.

In some embodiments, the congruity scoring processor is further configured to form the path through a node representing a demographic characteristic belonging to both the individual and to the reviewer.

In some embodiments, the congruity scoring processor is further configured to form the path through a node representing a product in the plurality of products that is connected by a first edge to a demographic characteristic of the individual, and is connected by a second edge to a product review made by the reviewer of the selected product.

In some embodiments, the congruity scoring processor is configured to compute the DC score for the reviewer by computing a path score for each path comprising nodes and edges in the graph between the node representing the reviewer and the node representing the individual, the path score equal to (a) the product of weights of each node in the path, divided by (b) the number of edges in the path; and computing the DC score as the sum of the path scores.

In some embodiments, the thresholding processor is configured to determine the threshold DC score on the basis of a fixed threshold, or a statistical measure of the computed DC scores, or using artificial intelligence according to a machine learning model, or any combination of these.

In some embodiments, the congruity scoring processor is configured to determine the DC score on the basis of graph theory, data mining techniques, nodes, links, associated link weights, degree, centrality, betweenness, geo-distance, and/or reviewer/individual(s) influence.

A second embodiment is a method of providing product reviews to an individual, the product reviews having been made by a plurality of reviewers. The method includes receiving a selection by the individual of a product from a plurality of products. The method next includes forming a graph having nodes representing the individual, the plurality of reviewers, demographic characteristics belonging to the individual and the plurality of reviewers, the plurality of products, and reviews of each of the plurality of products by the plurality of reviewers. The graph has edges representing relationships between the nodes. The method then includes, for each reviewer of the selected product, computing a respective demographic congruity (DC) score that relates a demographic closeness between the reviewer and the individual. The method concludes by providing simultaneously to the individual (a) statistics relating to a first group of all product reviews of the given product, and (b) statistics relating to a second group consisting of only those product reviews whose reviewer has a DC score that exceeds a threshold DC score.

In some embodiments, computing the DC score comprises forming a path comprising nodes and edges in the graph between the node representing the reviewer of the selected product and the node representing the individual.

In some embodiments, forming the path comprises forming the path through a node representing a demographic characteristic belonging to both the individual and to the reviewer.

In some embodiments, forming the path comprises forming the path through a node representing a product in the plurality of products that is connected by a first edge to a demographic characteristic of the individual, and is connected by a second edge to a product review made by the reviewer of the selected product.

In some embodiments, computing the DC score for each reviewer comprises computing a path score for each path comprising nodes and edges in the graph between the node representing the reviewer and the node representing the individual, the path score equal to (a) the product of weights of each node in the path, divided by (b) the number of edges in the path; and computing the DC score as the sum of the path scores.

In some embodiments, providing the statistics relating to the second group comprises determining the threshold DC score on the basis of a fixed threshold, or a statistical measure of the computed DC scores, or using artificial intelligence according to a machine learning model, or any combination of these.

In some embodiments, the DC score can be determined on the basis of graph theory, data mining techniques, nodes, links, associated link weights, degree, centrality, betweenness, geo-distance, and/or reviewer/individual(s) influence.

In some embodiments, the statistical measure comprises a score percentile.

A third embodiment is a tangible, computer-readable storage medium, in which is non-transitorily stored computer program code for performing the above-described method or any of its variants.

It is appreciated that the concepts, techniques, and structures disclosed herein may be embodied in other ways, and therefore the above summary of disclosed embodiments should not be viewed as limiting the scope of the inventive subject matter.

### BRIEF DESCRIPTION OF THE DRAWINGS

The manner and process of making and using the disclosed embodiments may be appreciated by reference to the drawings, in which:

FIG. 1 is a portion of an illustrative display, on a screen of an electronic device, of a selected product and its associated reviews according to an embodiment of the concepts, techniques, and structures disclosed herein;

FIG. 2 schematically shows a graph of data associated with individuals and product reviews, and relationships between these data;

FIG. 2A schematically shows the graph of FIG. 2 with emphasis on edges that form connections between reviewers and an individual requesting product reviews;

FIG. 3 is a flow diagram for a method of providing product reviews to the individual, in accordance with an embodiment;

FIG. 4 schematically shows components of a system for providing product reviews to the individual in accordance with an embodiment;

FIG. 5 schematically shows a typical client-server system in which the disclosed concepts, structures, and techniques may be advantageously embodied; and

FIG. 6 schematically shows relevant physical components of a computer system that may be used to embody, in whole or in part, the concepts, structures, and techniques disclosed herein.

### DETAILED DESCRIPTION OF EMBODIMENTS

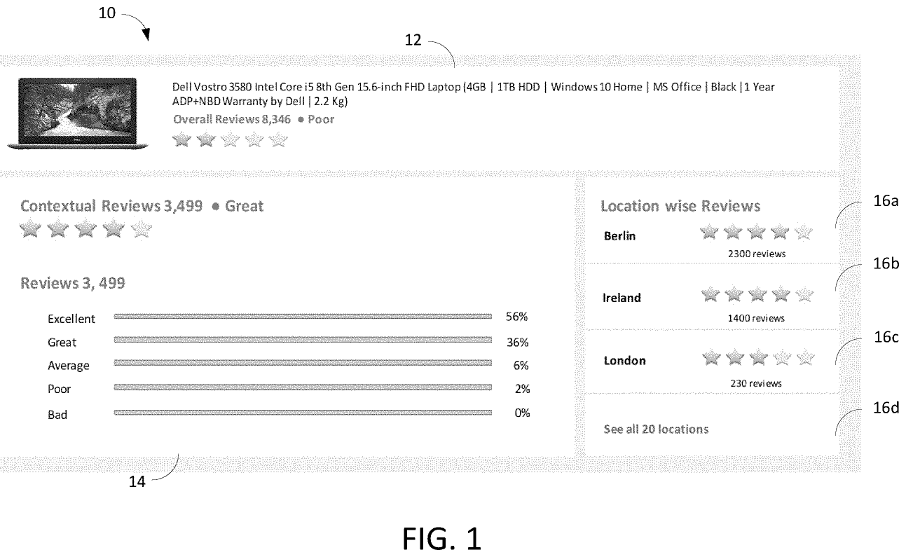

FIG. 1 is a portion of an illustrative display 10, on a screen of an electronic device, of a selected product and its associated reviews according to an embodiment of the concepts, techniques, and structures disclosed herein. The display 10 may be shown on the screen of any electronic device, including without limitation a desktop computer, a laptop computer, a tablet computer, a smartphone, or any similar electronic device. The particular components of the display 10 shown in FIG. 1 and described below, and their layout, are merely illustrative. Thus, it is appreciated that more or fewer such components may be displayed in an embodiment, in different arrangements on the screen, whether in landscape orientation as shown in FIG. 1 or in portrait orientation, and these display features may be customized according to criteria not discussed in detail herein, including without limitation the type of electronic device and the type of operating system or program executing in the electronic device for displaying the information (e.g. a web browser).

The display 10 includes a display component 12 that contains information about a product selected by an individual from a multitude of products. In the illustrative FIG. 1, the product is a Dell® Vostro 3580 laptop computer, and the display component 12 includes a thumbnail image of the product and a brief description thereof. As particularly relevant here, the display component 12 further includes summary statistics relating to reviews of the product, and in particular states that: 8,346 reviews have been submitted for this product; the overall rating of the product in those reviews is “Poor”; and the average “star” rating for the product is two stars.

In accordance with embodiments of the concepts, techniques, and structures disclosed herein, the display 10 further includes a display component 14 that contains information about demographically congruous reviews. As used herein, “demographically congruous” or “DC” means a relationship between a product reviewer and an individual in which a demographic score that relates the reviewer and the individual exceeds a threshold, and a “demographically congruous review” is a product review made by a reviewer who is demographically congruous with respect to a particular individual in question. It may be appreciated from these definitions that DC reviews will, in general, be made by reviewers who are more closely aligned demographically with the given individual than the average reviewer of a given product, regardless of product or the given individual. That is, the reviews considered demographically congruous will vary according to the given individual seeking those reviews.

The manner in which DC reviewers are determined with respect to any given individual is described in more detail below. However, it may be understood from FIG. 1 and the display component 14 that: of the 8,346 total reviews, only 3,499 of them are DC; that the overall rating of the product in the DC reviews is “Great”; the average “star” rating for the product in the DC reviews is four stars; and that over half of the DC reviewers gave the product an “Excellent” or five star rating. That is, while the average review of the product was “Poor”, reviewers who are demographically congruous with the browsing individual had a much different opinion. In accordance with embodiments, individuals advantageously may have a more tailored, and thus more enjoyable experience browsing for products, given this additional, contextual information associated with each product.

The display 10 further includes display components 16a, 16b, 16c, 16d providing additional product information interactive functionality. Thus, component 16a indicates that 2300 reviewers in Berlin gave the product an average “star” rating of four stars. Component 16b indicates that 1400 reviewers in Ireland gave the product an average “star” rating of four stars. Component 16c indicates that 230 reviewers in London gave the product an average “star” rating of three stars. And component 16d provides a link for the browsing individual to click to access data collected from twenty such locations.

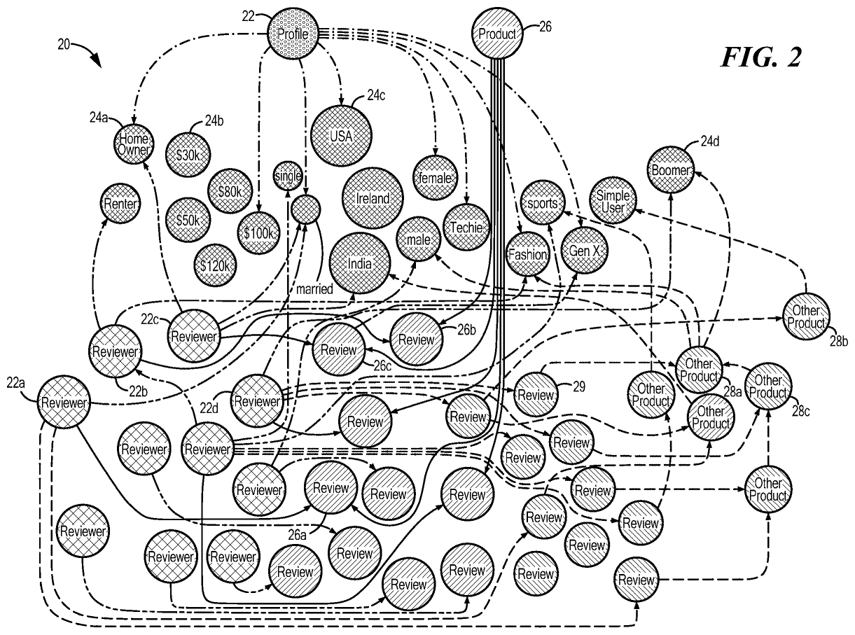

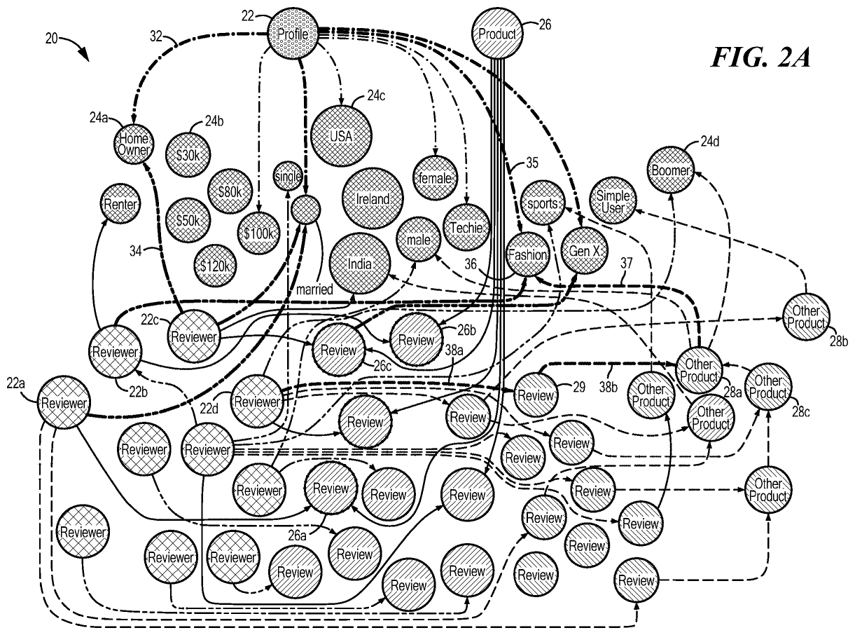

FIG. 2 schematically shows a graph 20 of data associated with individuals and product reviews, and relationships between these data. That is, the graph 20 is a visualization of data that may be stored in a database and is representative of the relevant people and reviews. Thus, the graph 20 may be embodied in one or more data structures designed for the purpose of enabling computations using graphs, and these data structures may be implemented in the memory of a computer or other electronic device having a computing processor for performing the computations.

In FIG. 2, each depicted circle is a “node” of the graph 20, as that word is used in the art. Different nodes are depicted as having different diameters for the purpose of illustrating the concept that each node has an associated “weight” that is used in scoring, as described below. Nodes are connected to other nodes via curvilinear “edges” of the graph 20 when there is a relevant relationship between the nodes. Some edges are omitted for the sake of clarity, and it should be understood that graphs in embodiments may have more or fewer nodes, different weights, more or fewer edges connecting the nodes, and may include nodes that represent different people or things than those described herein. That is, it is appreciated that FIGS. 2 and 2A are merely illustrative of the concepts, techniques, and structures disclosed herein, and that a person having ordinary skill in the art will know how to adapt these teachings to different situations.

The graph 20 includes a node 22 that represents the profile of an individual interacting with the reviews. In this disclosure, this individual is designated the “browsing individual,” as it is expected that, in typical embodiments, the individual will be interacting with products via the display 10 on a browser. This designation should not be viewed as limiting in any way, but is adopted merely for reference.

The graph 20 further includes nodes 24a, 24b, 24c, 24d (collectively “demographic nodes”) relating to demographic characteristics. For example, node 24a represents the demographic characteristic of being a homeowner, as opposed to a renter. Node 24b represents the demographic characteristic of an income bracket including $30,000 per year, as opposed to other income brackets shown. Node 24c represents the demographic characteristic of living in the United States, as opposed to another country. And node 24d represents the demographic characteristic of being a “baby boomer,” as opposed to being in “generation X.”

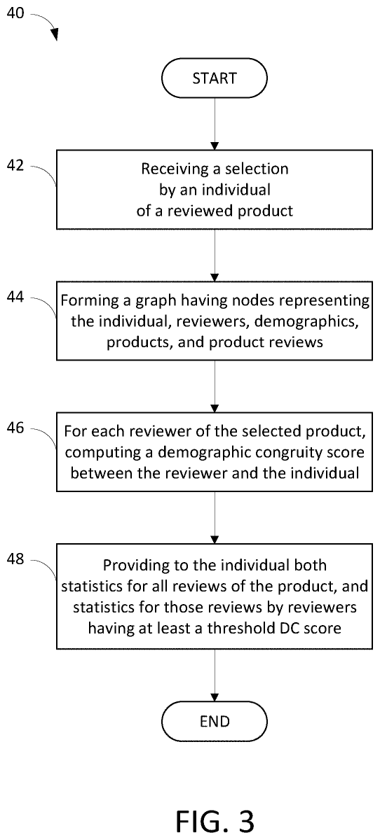

As shown in FIG. 2, some of the demographic nodes are larger than others; that is, they have greater weights, and are thus considered “more important” to the scoring algorithm described below in connection with FIG. 3. For example, a scoring algorithm in accordance with the weights shown in FIG. 2 would view country of residence as the most important scoring factor, marital status as the least important scoring factor, and the other demographic characteristics as lying in between. It is appreciated that the relative weights are adapted to a particular implementation of the scoring algorithm, and that other implementations may be designed to have different weights, so FIGS. 2 and 2A should be viewed as merely illustrative of the concept of nodes having different weights.

Edges connect the profile 22 to the demographic nodes that describe the browsing individual. Thus, it may be appreciated from FIG. 2 that, for the particular graph 20 shown therein, the browsing individual is a homeowner, makes approximately $100,000 per year, is married, lives in the United States, is female, is a “techie,” is interested in fashion, and is in “generation X.” It should be understood that different browsing individuals will have different demographics, and thus give rise to different profiles 22 and different edges to the nodes 24, resulting in different graphs of which graph 20 is but illustrative.

The graph 20 further includes nodes 22a, 22b, 22c, 22d (collectively “reviewer nodes”) that represent profiles of various product reviewers. Edges connect each reviewer node to the nodes 24 relating to demographic characteristics of the corresponding reviewer. Thus, profile 22b is for a reviewer who is a renter, while profile 22c is for a reviewer who is a homeowner.

The graph 20 also includes a node 26 that represents a product with which the browsing individual is presently associated. That is, the browsing individual has searched for or otherwise requested information about the product, and it is desired to display demographically congruous reviews responsively to the individual with respect to that product.

The graph 20 has nodes 26a, 26b, 26c (collectively “review nodes”) that represent product reviews of the product represented by node 26. Edges connect the product node 26 to the review nodes for each of the associated reviews. Moreover, edges connect the reviewer nodes to their respective review nodes. In particular, an edge connects the reviewer with node 22a to the review with node 26a, an edge connects the reviewer with node 22b to the review with node 26b, and an edge connects the reviewer with node 22c to the review with node 26c.

The graph 20 also has nodes 28a, 28b, 28c (collectively “other product nodes”) that represent products other than the product of node 26, and other nodes, such as node 29, that represent product reviews of the other products. Edges connect the other product nodes to their respective reviews; for example, node 29 represents a product review of the “other product” represented by node 28a.

It is appreciated that the relationship of products to reviews is not a function of this labeling. In other words, the labeling of the nodes in the graph 20 as belonging to “the product” (i.e. node 26) or “other products” (i.e. the other product nodes) is determined by the context in which the graph 20 is viewed, and in particular what product is being browsed, and thus does not necessarily require the addition or subtraction of nodes or edges. Likewise, it is anticipated that the browsing individual represented by node 22 may herself be a product reviewer, and in that capacity, at other times, be represented in the graph 20 by a reviewer node with respect to a different browsing individual.

FIG. 2A schematically shows the graph 20 of FIG. 2 with emphasis on edges that form connections between reviewers and an individual requesting product reviews. In accordance with embodiment of the concepts, techniques, and structures disclosed herein, such connections are used to determine demographic congruity (DC) between product reviewers and the browsing individual. Two kinds of DC are discussed below: congruity on the basis of a demographic characteristic shared between the reviewer and the browsing individual, and congruity on the basis of a demographic characteristic associated with a product reviewed by the reviewer (whether the product in question or another product). It is appreciated that there may be other types of connections that provide demographic congruity, and thus that the two kinds of DC discussed herein are merely illustrative and do not limit the scope of the inventive subject matter.

The first kind of DC, namely profile-shared DC, is now illustrated with reference to FIG. 2A. Thus, from the graph 20 it may be determined that the reviewer having profile 22b lacks a demographic characteristic (home ownership) that the reviewer having profile 22c shares with the browsing individual having profile 22, and therefore that the latter reviewer has a connection to, and is more congruous with, the browsing individual in that particular demographic. This is indicated by the thick arrow 32 from the profile node 22 of the browsing individual to the demographic characteristic 24a of home ownership, and the thick arrow 34 from the profile node 22c of that reviewer to the same demographic characteristic 24a. These two arrows (or edges) 32, 34 in the graph form a path of length two between the profiles of the reviewer 22c and the browsing individual 22, and containing an intermediate node 24a having a particular weight.

The second kind of DC, namely product-shared DC, is now illustrated with reference to FIG. 2A. Thus, from the graph 20 it may be determined that the browsing individual is interested in fashion, as shown by the thick arrow 35 between the individual's profile node 22 and the fashion node 36; that another product is associated with that demographic characteristic, as shown by the thick arrow 37 between the other product node 28a and the fashion node 36; and that the reviewer having profile 22d has reviewed the other product 28a, as shown by the thick arrows 38a from the node 22d to the review node 29 of the other product, and 38b from the review node 29 to the other product node 28a. These four arrows (or edges) 35, 37, 38a, and 38b in the graph form a path of length four between the profiles of the reviewer 22d and the browsing individual 22, and containing three intermediate nodes having particular weights.

Observe that, for product-shared DC, the review nodes 26a, 26b, 26c for the product in question (having node 26) are given a greater weight than the review nodes (e.g. node 29) for the other products having nodes 28a, 28b, 28c. This node weighting ultimately gives higher scores to the profile-shared paths than to the product-shared paths, as described below. It is appreciated that this choice is merely one of design, and that in other situations it may be more appropriate to give all product review nodes an equal weight. In this regard, the weighting of the product review nodes in FIGS. 2 and 2A should be viewed as merely illustrative.

Having now described the individuals, reviewers, demographic characteristics, products and product reviews shown in FIGS. 2 and 2A, and the various connections they might have, FIG. 3 is a flow diagram for a method 40 of providing product reviews, made by product reviewers, to an individual (e.g. the browsing individual), in accordance with an embodiment of the concepts, techniques, and structures disclosed herein. In illustrative embodiments, the individual is a browsing individual who has selected a product from a list of products displayed on a website, and desires to receive the product reviews on a web page, for example as shown in FIG. 1. A person having ordinary skill in the art should understand how to adapt the method 40 to provide product reviews in a manner that is tailored to other situations.

The method 40 begins with a receiving process 42 for receiving a selection, by the individual, of a product from a plurality of products. The selection may be received, for example, by a server computer from a client computer of the individual.

The method 40 continues with a forming process 44 for forming a graph, having nodes and edges, that is similar to the graph 20 of FIGS. 2 and 2A. Thus, one of the nodes represents the individual. Some of the nodes represent the plurality of product reviewers. Some of the nodes represent demographic characteristics belonging to the individual and some of the plurality of reviewers. Some of the nodes represent the plurality of products. And some of the nodes represent reviews of each of the plurality of products by the plurality of reviewers. The graph has edges representing relationships between the nodes, e.g. relationships between reviewers and their reviews as discussed above. The forming process 44 may be implemented, for example, by a computing processor forming data structures within a memory device, and may draw upon data stored in a database or other non-volatile data storage medium.

The method 40 advances to a computing process 46 for computing a demographic congruity (DC) score between each reviewer of the selected product and the individual. The DC score relates a demographic closeness between the reviewer and the individual. In accordance with an embodiment of the invention, the DC score is computed, in part, by forming a path comprising nodes and edges in the graph between the node representing the reviewer of the selected product and the node representing the individual, and assigning a score to the path. The path may be the result of a profile-shared DC, or a product-shared DC, as described above in connection with FIG. 2A. That is, in the first case, the path is formed through a node (e.g. node 24a) representing a demographic characteristic belonging to both the individual (e.g. node 22) and to the reviewer (e.g. node 22c). In the second case, the path is formed through a node (e.g. 28a) representing a product in the plurality of products that is connected by a first edge (e.g. edge 37) to a demographic characteristic of the individual (e.g. node 36), and is connected by a second edge (e.g. edge 38b) to a product review (e.g. node 29) made by the reviewer of the selected product (e.g. node 22d).

Having formed the path, the computing process 46 then computes a path score. Recall that each node in the graph may be assigned a characteristic relevance weight. In accordance with a typical embodiment, the path score is computed as the product of weights of each node in the path, divided by the number of edges in the path. Illustratively, the profile-shared DC score for the path consisting of the edges 32 and 34 in FIG. 2A equals the weight of the node 24 divided by two. Also illustratively, the product-shared DC score for the path consisting of the edges 35, 37, 38a, and 38b in FIG. 2A equals the product of the weights of the nodes 36, 28a, and 29 divided by four. Thus, if each node has a weight between zero and one, the illustrative profile-shared DC score will have a greater value than the illustrative product-shared DC score, as mentioned above in connection with FIG. 2A.

It is appreciated that other formulas may be used to compute a DC score for each path in the graph. For example, the length of the path may be raised to an exponential power for purposes of increasing or decreasing its effect on the overall score, or edges may be provided with weights and the weights of the edges added to form the total path length. A person having ordinary skill in the art should understand how the formulas described herein may be modified to adapt to other situations, and may produce greater or lesser scores for paths as a function of node weights and path lengths.

In a typical embodiment, the computing process 46 determines, for each reviewer of the given product in question, all paths connecting the reviewer with the browsing individual, and computes a path score for each path. Then the DC score for each reviewer comprises the sum of the path scores. In this way, the more demographic connections any given reviewer has to the browsing individual, the greater the final DC score will be. This approach advantageously increases the DC scores for reviewers who make many reviews of products in which the browsing individual may have an interest. However, with appropriate weighting, a reviewer who does not review as many products nevertheless may have a relatively high DC score if her demographics closely align with those of the browsing individual.

The method 40 concludes with a process 48 for providing simultaneously to the individual (a) statistics relating to a first group of all product reviews of the given product, and (b) statistics relating to a second group consisting of only those product reviews whose reviewer has a DC score that exceeds a threshold DC score. In a typical embodiment in which the browsing individual has selected the product from a website, providing these statistics is part of creating a web page responsive to the selection, e.g. a web page that appears like FIG. 1. Thus, the statistics relating to the first group of product reviews may appear in a display component such as component 12, while the statistics relating to the second group of contextual product reviews may appear in a different display component such as component 14. It is appreciated that some embodiments may omit the statistics relating to the first group of all product reviews in order to provide only the most appropriate reviews, and thus the method 40 should be viewed as merely illustrative in this regard.

The process 48 includes a thresholding subprocess, which may determine the threshold DC score. The threshold may be determined in several different manners. In one example, the threshold may be a statistical measure or rule based. Thus, the process 48 may provide statistics relating only to reviews with a DC score above a fixed number that represents a minimum demographic contiguity, which may be determined to provide a subjectively optimal experience for the browsing individual. Alternately, the threshold may be set at the “top 25%” or “top 10%” of the scores, as determined by ordering the DC scores after computation. Or, the threshold may be set at the “top 25%” of all scores above a minimum DC floor.

Alternately, the threshold may be calculated using Artificial Intelligence (AI) or Machine Learning (ML) models. The training for the models may be supervised or unsupervised, and include techniques (among others) of using ordinary least squares, linear least squares, linear regression, logistic regression, polynomial regression, stepwise regression, ridge regression, lasso regression, elastic net regression or another, similar regression algorithm. Training data may include historic behaviors and organizational service level agreement rules, or other appropriate training data. It will be recognized by a person having ordinary skill in the art, in view of the present disclosure, that the threshold may be obtained in a variety of different manners either rule based, statically or using Artificial Intelligence, Machine Learning models in conjunction with the DC. It is appreciated that other thresholding criteria may be used, and will be known to a person having ordinary skill in the art.

It will also be recognized, in view of the present disclosure, that a DC score may be obtained in a variety of different manners other than using the graph as just described. Thus, using other data mining techniques for producing a DC score include link analysis or social network analysis in conjunction with a statistically-derived node threshold, rule based, or AI/ML models. Link analysis and/or social network analysis would compute the DC score using an affinity model, or a viral adoption model, or other models known in the art, either alone or in combination. These models would take into consideration nodes, links, and associated link weights, among other things. The DC score would then be computed based on one or more factors including: degree, centrality, betweenness, geo-distance, and influence of the reviewer(s) and the individual(s) associated with the product.

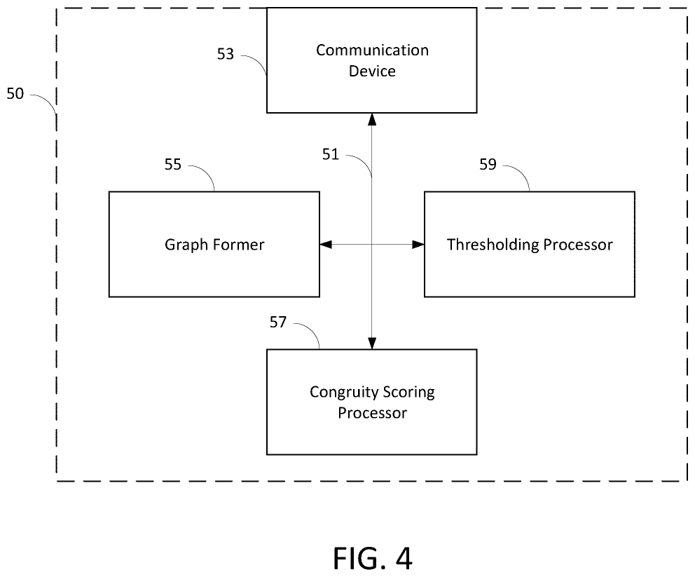

FIG. 4 schematically shows components of a system 50 for providing product reviews to the individual in accordance with an embodiment. Thus, the system 50 may implement the method 40 of FIG. 3.

The system 50 includes a number of components that are mutually coupled by a data communication bus 51. The bus 51 may be, for example, a collection of parallel wires as is known in the art of computing. It is appreciated that various embodiments may provide direct connections only between certain pairs of the components, for example to reduce manufacturing costs, so it should be understood that the bus 51 is shown as mutually coupling all of the other components in the system 50 for each of description, and not to limit the scope of the inventive subject matter.

The system 50 includes a communication device 53 for communicating with a client device of an individual. The communication device 53 may be, without limitation, a connection to a data network such as the Internet, and may be implemented using a network interface card (NIC) or similar device. The communication device 53 is configured to receive a selection by the individual of a product from a plurality of products. The communication device 53 is further configured to provide simultaneously to the individual (a) statistics relating to a first group of all product reviews of the given product, and (b) statistics relating to a second group consisting of only those product reviews whose reviewer has a DC score that exceeds the threshold DC score. The communication device 53 therefore may implement the processes 42 and 48 of the method 40 shown in FIG. 3.

The system 50 also includes a graph former 55 configured to form a graph having nodes and edges. The nodes represent the individual, the plurality of reviewers, demographic characteristics belonging to the individual and each of the plurality of reviewers, the plurality of products, and reviews of each of the plurality of products by the plurality of reviewers. The edges represent relationships between the nodes. The graph former 55 may be provided as a computing processor and a memory, or other hardware (with or without software) that is capable of performing the above-described functions. The graph former 55 may implement the process 44 of the method 40 shown in FIG. 3.

The system 50 further includes a congruity scoring processor 57 that is configured to compute, for each reviewer of the selected product, a respective demographic congruity (DC) score that relates a demographic closeness between the reviewer and the individual. The congruity scoring processor 57 also may be provided as a computing processor and a memory, or other hardware (with or without software) that is capable of performing the above-described functions. The congruity scoring processor 57 may implement the process 46 of the method 40 shown in FIG. 3.

The system 50 finally includes a thresholding processor 59 configured to determine a threshold DC score. The thresholding processor 59 also may be provided as a computing processor and a memory, or other hardware (with or without software) that is capable of performing the above-described functions. The thresholding processor 59 may implement the process 48 of the method 40 shown in FIG. 3 in conjunction with the communication device 53.

It is appreciated that the performance of some of the above-described functions advantageously may be combined in hardware or software. Therefore, some embodiments provide a single server device that provides some or all of these functions. However, such advantageous combinations are not always required, and this observation should not be viewed as limiting the scope of the inventive subject matter of FIG. 4.

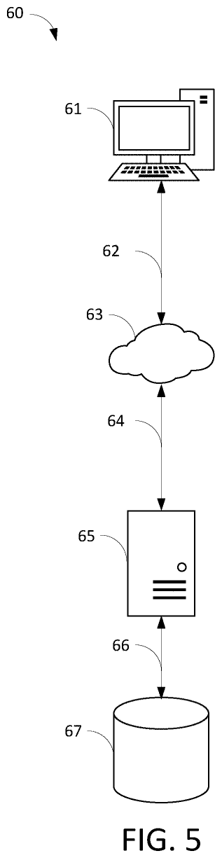

FIG. 5 schematically shows a typical client-server system 60 in which the above-disclosed concepts, structures, and techniques may be advantageously embodied. In accordance with client-server principles, the system 60 includes at least one client device coupled for bidirectional data communication with at least one server device using a data network. Generally, the client requests, via the data network, that the server perform a computation or other function, and the server responsively fulfills the request, optionally returning a result or status indicator to the client via the data network.

Thus, the system 60 includes a client device 61. The client device 61 is illustrated as a desktop computer, but may be any electronic device known in the art, including without limitation a laptop computer, tablet computer, smartphone, embedded system, or any other device capable of transmitting and receiving data, and requesting that another electronic device perform a computation. In particular, the client device 61 may be the client device referred to in connection with FIG. 4 above.

The client device 61 is coupled, via a data link 62, to a data network 63. The data link 62 is any combination of hardware or software suited for communicating data between the client device 61 and other electronic devices via the data network 63. The data link 62 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

The data network 63 is any combination of hardware or software suited for communicating data between electronic devices via data links. The data network 63 may be, for example, a local area network (“LAN”), a wide area network (“WAN”), a metropolitan area network (“MAN”), a virtual private network (“VPN”), the Internet, or any other type of data network.

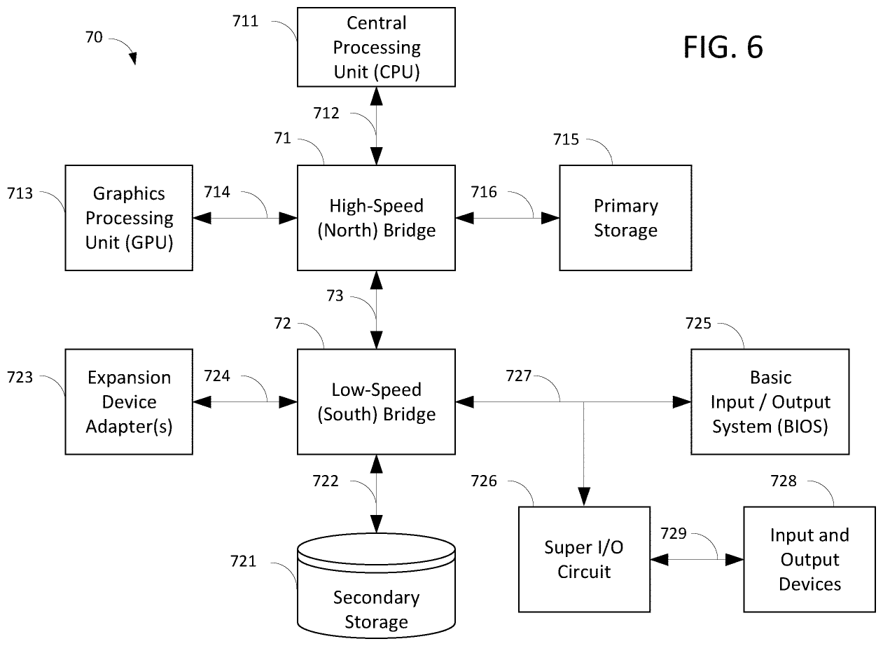

It is appreciated that a data network 63 operates to mediate data communication between multiple electronic devices. Thus, the depiction of only a single client device 61 in FIG. 6 is merely illustrative, and a typical system 60 may have any number of client devices coupled for data communication using corresponding data links to the data network 63. It is also appreciated that the data network 63 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

The data network 63 allows the client device 61 to communicate with a server device 65, which is coupled to the data network 63 using a data link 64. The data link 64 is any combination of hardware or software suited for communicating data between the server device 65 and other electronic devices via the data network 63. The server device 65 may be any electronic device known in the art that is capable of transmitting and receiving data, and performing a computation on behalf of another electronic device. In particular, the server device 65 may implement, in whole or in part, the system 50 for providing product reviews to the individual in accordance with an embodiment.

Again, the data network 63 operates to mediate data communication between multiple electronic devices. Thus, the depiction of only a single server device 65 in FIG. 5 is merely illustrative, and a typical system 60 may have any number of server devices coupled for data communication using corresponding data links to the data network 63. In particular, to provide simultaneous service to large numbers of client devices, a particular computation (or type of computation, such as rendering a web page) may be allocated to one of multiple server devices using a load balancer or other device. It is further appreciated that the server device 65, along with additional server devices if required, may provide well-defined operations known as “services” according to a service-oriented architecture (“SOA”), as those terms are known in the art.

It is appreciated in accordance with client-server principles that the designation of device 61 as the “client device” and device 65 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of the system 60, namely that the client device 61 is the device requesting that a particular computation be performed on behalf of a user thereof, and that the server device 65 operates a “service” to perform the computation and communicate the results to the client device 61. A typical protocol for such interaction is the Hypertext Transfer Protocol (“HTTP” or “HTTP/1.1”) specified as a proposed Internet Standard by Requests for Comment (“RFC”) 7230 through 7235, which is used to implement the World Wide Web.

FIG. 5 shows the server device 65 coupled, via a storage link 66, to a data storage device 67. The data storage device 67 may be a database, file system, volatile or non-volatile memory, network attached storage (“NAS”), storage area network (“SAN”), or any other hardware or software that is capable of storing data used by a server device 65 or a service executing thereon. The storage link 66 may be any hardware or software capable of communicating data between the server device 65 and the data storage device 67. It is appreciated that, where more than one server device 65 is present, multiple server devices may communicate with the same data storage device 67 to provide data sharing between the server devices.

It is appreciated that a requested computation may be done in several parts, thereby requiring the system 60 to retain an intermediate computational state between requests. If the services provided by the server device 65 do not store any such state (for example, to simplify their design), then the client device 61 must supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

FIG. 6 schematically shows relevant physical components of a computer 70 that may be used to embody the concepts, structures, and techniques disclosed herein. In particular, a computer 70 may implement, in whole or in part, the client device displaying the display 10 of FIG. 1; the system forming the graphs 20 of FIGS. 2 and 2A; the system implementing the method 40 of FIG. 3; the system 50 of FIG. 4; the client device 61 of FIG. 5; or the server device 65 of FIG. 5, or any of these. Generally, the computer 70 has many functional components that communicate data with each other using data buses. The functional components of FIG. 6 are physically arranged based on the speed at which each must operate, and the technology used to communicate data using buses at the necessary speeds to permit such operation.

Thus, the computer 70 is arranged as high-speed components and buses 711 to 716 and low-speed components and buses 721 to 729. The high-speed components and buses 711 to 716 are coupled for data communication using a high-speed bridge 71, also called a “northbridge,” while the low-speed components and buses 721 to 729 are coupled using a low-speed bridge 72, also called a “southbridge.”

The computer 70 includes a central processing unit (“CPU”) 711 coupled to the high-speed bridge 71 via a bus 712. The CPU 711 is electronic circuitry that carries out the instructions of a computer program. As is known in the art, the CPU 711 may be implemented as a microprocessor; that is, as an integrated circuit (“IC”; also called a “chip” or “microchip”). In some embodiments, the CPU 711 may be implemented as a microcontroller for embedded applications, or according to other embodiments known in the art.

The bus 712 may be implemented using any technology known in the art for interconnection of CPUs (or more particularly, of microprocessors). For example, the bus 712 may be implemented using the HyperTransport architecture developed initially by AMD, the Intel QuickPath Interconnect (“QPI”), or a similar technology. In some embodiments, the functions of the high-speed bridge 71 may be implemented in whole or in part by the CPU 711, obviating the need for the bus 712.

The computer 70 includes one or more graphics processing units (GPUs) 713 coupled to the high-speed bridge 71 via a graphics bus 714. Each GPU 713 is designed to process commands from the CPU 711 into image data for display on a display screen (not shown). In some embodiments, the CPU 711 performs graphics processing directly, obviating the need for a separate GPU 713 and graphics bus 714. In other embodiments, a GPU 713 is physically embodied as an integrated circuit separate from the CPU 711 and may be physically detachable from the computer 70 if embodied on an expansion card, such as a video card. The GPU 713 may store image data (or other data, if the GPU 713 is used as an auxiliary computing processor) in a graphics buffer.

The graphics bus 714 may be implemented using any technology known in the art for data communication between a CPU and a GPU. For example, the graphics bus 714 may be implemented using the Peripheral Component Interconnect Express (“PCI Express” or “PCIe”) standard, or a similar technology.

The computer 70 includes a primary storage 715 coupled to the high-speed bridge 71 via a memory bus 716. The primary storage 715, which may be called “main memory” or simply “memory” herein, includes computer program instructions, data, or both, for use by the CPU 711. The primary storage 715 may include random-access memory (“RAM”). RAM is “volatile” if its data are lost when power is removed, and “non-volatile” if its data are retained without applied power. Typically, volatile RAM is used when the computer 70 is “awake” and executing a program, and when the computer 70 is temporarily “asleep”, while non-volatile RAM (“NVRAM”) is used when the computer 70 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 716 may be implemented using any technology known in the art for data communication between a CPU and a primary storage. The memory bus 716 may comprise an address bus for electrically indicating a storage address, and a data bus for transmitting program instructions and data to, and receiving them from, the primary storage 715. For example, if data are stored and retrieved 64 bits (eight bytes) at a time, then the data bus has a width of 64 bits. Continuing this example, if the address bus has a width of 32 bits, then 2³² memory addresses are accessible, so the computer 70 may use up to 8*2³²=32 gigabytes (GB) of primary storage 715. In this example, the memory bus 716 will have a total width of 64+32=96 bits. The computer 70 also may include a memory controller circuit (not shown) that converts electrical signals received from the memory bus 716 to electrical signals expected by physical pins in the primary storage 715, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 711, the graphics processing units 713, the primary storage 715, and the high-speed bridge 71, or any combination thereof, as a single integrated circuit. In such embodiments, buses 712, 714, 716 may form part of the same integrated circuit and need not be physically separate. Other designs for the computer 70 may embody the functions of the CPU 711, graphics processing units 713, and the primary storage 715 in different configurations, obviating the need for one or more of the buses 712, 714, 716.

The depiction of the high-speed bridge 71 coupled to the CPU 711, GPU 713, and primary storage 715 is merely exemplary, as other components may be coupled for communication with the high-speed bridge 71. For example, a network interface controller (“NIC” or “network adapter”) may be coupled to the high-speed bridge 71, for transmitting and receiving data using a data channel. The NIC may store data to be transmitted to, and received from, the data channel in a network data buffer.

The high-speed bridge 71 is coupled for data communication with the low-speed bridge 72 using an internal data bus 73. Control circuitry (not shown) may be required for transmitting and receiving data at different speeds. The internal data bus 73 may be implemented using the Intel Direct Media Interface (“DMI”) or a similar technology.

The computer 70 includes a secondary storage 721 coupled to the low-speed bridge 72 via a storage bus 722. The secondary storage 721, which may be called “auxiliary memory”, “auxiliary storage”, or “external memory” herein, stores program instructions and data for access at relatively low speeds and over relatively long durations. Since such durations may include removal of power from the computer 70, the secondary storage 721 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 722 may be implemented using any technology known in the art for data communication between a CPU and a secondary storage and may include a host adaptor (not shown) for adapting electrical signals from the low-speed bridge 72 to a format expected by physical pins on the secondary storage 721, and vice versa. For example, the storage bus 722 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 70 also includes one or more expansion device adapters 723 coupled to the low-speed bridge 72 via a respective one or more expansion buses 724. Each expansion device adapter 723 permits the computer 70 to communicate with expansion devices (not shown) that provide additional functionality. Such additional functionality may be provided on a separate, removable expansion card, for example an additional graphics card, network card, host adaptor, or specialized processing card.

Each expansion bus 724 may be implemented using any technology known in the art for data communication between a CPU and an expansion device adapter. For example, the expansion bus 724 may transmit and receive electrical signals using a Peripheral Component Interconnect (“PCI”) standard, a data networking standard such as an Ethernet standard, or a similar technology.

The computer 70 includes a basic input/output system (“BIOS”) 725 and a Super I/O circuit 726 coupled to the low-speed bridge 72 via a bus 727. The BIOS 725 is a non-volatile memory used to initialize the hardware of the computer 70 during the power-on process. The Super I/O circuit 726 is an integrated circuit that combines input and output (“I/O”) interfaces for low-speed input and output devices 728, such as a serial mouse and a keyboard. In some embodiments, BIOS functionality is incorporated in the Super I/O circuit 726 directly, obviating the need for a separate BIOS 725.

The bus 727 may be implemented using any technology known in the art for data communication between a CPU, a BIOS (if present), and a Super I/O circuit. For example, the bus 727 may be implemented using a Low Pin Count (“LPC”) bus, an Industry Standard Architecture (“ISA”) bus, or similar technology. The Super I/O circuit 726 is coupled to the I/O devices 728 via one or more buses 729. The buses 729 may be serial buses, parallel buses, other buses known in the art, or a combination of these, depending on the type of I/O devices 728 coupled to the computer 70.

The concepts, techniques, and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system for providing product reviews to an individual, the product reviews having been made by a plurality of reviewers, the system comprising:
a communication device configured to receive a selection by the individual of a product from a plurality of products;
a graph former configured to form a graph having nodes representing the individual, the plurality of reviewers, demographic characteristics belonging to the individual and each of the plurality of reviewers, the plurality of products, and reviews of each of the plurality of products by the plurality of reviewers, the graph having edges representing relationships between the nodes;
a congruity scoring processor, coupled to the graph former and the communication device, the congruity scoring processor configured to compute, for each reviewer of the selected product, a respective demographic congruity (DC) score that relates a demographic closeness between the reviewer and the individual; and
a thresholding processor, coupled to the congruity scoring processor and to the communication device, the thresholding processor configured to determine a threshold DC score;
the communication device further configured to provide simultaneously to the individual (a) statistics relating to a first group of all product reviews of the given product, and (b) statistics relating to a second group consisting of only those product reviews whose reviewer has a DC score that exceeds the threshold DC score.

2. The system according to claim 1, wherein the congruity scoring processor is further configured to form a path comprising nodes and edges in the graph between the node representing the reviewer of the selected product and the node representing the individual.

3. The system according to claim 2, wherein the congruity scoring processor is further configured to form the path through a node representing a demographic characteristic belonging to both the individual and to the reviewer.

4. The system according to claim 2, wherein the congruity scoring processor is further configured to form the path through a node representing a product in the plurality of products that is connected by a first edge to a demographic characteristic of the individual, and is connected by a second edge to a product review made by the reviewer of the selected product.

5. The system according to claim 1, wherein the congruity scoring processor is configured to compute the DC score for the reviewer by:
computing a path score for each path comprising nodes and edges in the graph between the node representing the reviewer and the node representing the individual, the path score equal to (a) the product of weights of each node in the path, divided by (b) the number of edges in the path; and
computing the DC score as the sum of the path scores.

6. The system according to claim 1, wherein the thresholding processor is configured to determine the threshold DC score on the basis of a fixed threshold, or a statistical measure of the computed DC scores, or using artificial intelligence according to a machine learning model, or any combination of these.

7. A method of providing product reviews to an individual, the product reviews having been made by a plurality of reviewers, the method comprising:
receiving a selection by the individual of a product from a plurality of products;
forming a graph having nodes representing the individual, the plurality of reviewers, demographic characteristics belonging to the individual and the plurality of reviewers, the plurality of products, and reviews of each of the plurality of products by the plurality of reviewers, the graph having edges representing relationships between the nodes;
for each reviewer of the selected product, computing a respective demographic congruity (DC) score that relates a demographic closeness between the reviewer and the individual; and
providing simultaneously to the individual (a) statistics relating to a first group of all product reviews of the given product, and (b) statistics relating to a second group consisting of only those product reviews whose reviewer has a DC score that exceeds a threshold DC score.

8. The method according to claim 7, wherein computing the DC score comprises forming a path comprising nodes and edges in the graph between the node representing the reviewer of the selected product and the node representing the individual.

9. The method according to claim 8, wherein forming the path comprises forming the path through a node representing a demographic characteristic belonging to both the individual and to the reviewer.

10. The method according to claim 8, wherein forming the path comprises forming the path through a node representing a product in the plurality of products that is connected by a first edge to a demographic characteristic of the individual, and is connected by a second edge to a product review made by the reviewer of the selected product.

11. The method according to claim 7, wherein computing the DC score for each reviewer comprises:
computing a path score for each path comprising nodes and edges in the graph between the node representing the reviewer and the node representing the individual, the path score equal to (a) the product of weights of each node in the path, divided by (b) the number of edges in the path; and
computing the DC score as the sum of the path scores.

12. The method according to claim 7, wherein providing the statistics relating to the second group comprises determining the threshold DC score on the basis of a fixed threshold, or a statistical measure of the computed DC scores, or using artificial intelligence according to a machine learning model, or any combination of these.

13. The method according to claim 12, wherein the statistical measure comprises a score percentile.

14. A tangible, computer-readable storage medium, in which is non-transitorily stored computer program code for performing a method of providing product reviews to an individual, the product reviews having been made by a plurality of reviewers, the method comprising:
receiving a selection by the individual of a product from a plurality of products;
forming a graph having nodes representing the individual, the plurality of reviewers, demographic characteristics belonging to the individual and the plurality of reviewers, the plurality of products, and reviews of each of the plurality of products by the plurality of reviewers, the graph having edges representing relationships between the nodes;
for each reviewer of the selected product, computing a respective demographic congruity (DC) score that relates a demographic closeness between the reviewer and the individual; and
providing simultaneously to the individual (a) statistics relating to a first group of all product reviews of the given product, and (b) statistics relating to a second group consisting of only those product reviews whose reviewer has a DC score that exceeds a threshold DC score.

15. The storage medium according to claim 14, wherein computing the DC score comprises forming a path comprising nodes and edges in the graph between the node representing the reviewer of the selected product and the node representing the individual.

16. The storage medium according to claim 15, wherein forming the path comprises forming the path through a node representing a demographic characteristic belonging to both the individual and to the reviewer.

17. The storage medium according to claim 16, wherein forming the path comprises forming the path through a node representing a product in the plurality of products that is connected by a first edge to a demographic characteristic of the individual, and is connected by a second edge to a product review made by the reviewer of the selected product.

18. The storage medium according to claim 14, wherein computing the DC score for each reviewer comprises:
computing a path score for each path comprising nodes and edges in the graph between the node representing the reviewer and the node representing the individual, the path score equal to (a) the product of weights of each node in the path, divided by (b) the number of edges in the path; and
computing the DC score as the sum of the path scores.

19. The storage medium according to claim 14, wherein providing the statistics relating to the second group comprises determining the threshold DC score on the basis of a fixed threshold, or a statistical measure of the computed DC scores, or using artificial intelligence according to a machine learning model, or any combination of these.

20. The storage medium according to claim 19, wherein the statistical measure comprises a score percentile.
